(19) United States
(12) Patent Application Publication
(10) Pub. No.: US 2007/0074156 A1
(43) Pub. Date: Mar. 29, 2007

(54) Componentization of software computer programs

(75) Inventors: Bruce L. Nelson, Woodinville, WA (US); Daniel Roman, Seattle, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/219,054

(22) Filed: Sep. 1, 2005

(51) Int. Cl. G06F 9/44

(52) U.S. Cl. 717/107; 717/120; 717/104

(57) ABSTRACT

A set of data items and their possible values associated with an aspect of a computer program is encapsulated 23 into a container along with an associated action 25 of the computer program. Interaction between the containers is enabled by binding output of some containers into inputs of others 27. The containers are then organized into a hierarchy such that actions of child containers are triggered by parent containers 29. Once the entire program has been componentized 31, the componentization process is complete 33 and testing of the program or building new programs based on the components is possible. A graphical user interface (GUI) shell is used to change items and add or remove containers without a need to recompile the program.

### COPYRIGHT NOTICE AND PERMISSION

A portion of the disclosure of this patent document may contain material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice shall apply to this document: Copyright© 2005, Microsoft Corp.

### BACKGROUND

Developing tests or prototypes of new application programming interfaces (APIs) usually is a slow endeavor that requires partial or total re-engineering of existing tools. Tests developed through classic methods are also quite rigid and hard to change; they're often difficult to maintain by someone other than the original developer. Also, there is currently not an intuitive interface for developers to quickly build tests and prototypes of computer programs without having to write code. This results in time consuming and costly endeavors to either code new tests and prototypes or revisions of previous tests a the source-code level.

In this regard, there is a need for a rapid way to develop tests without having to write any code, an interactive and dynamic way to change the test at the API level through a graphical user interface (GUI) with simple drag-and-drop operations, to reduce total cost of ownership (TCO) costs by allowing the developer to focus more on test design rather than API details, and to allow other programmers to change tests without having to recompile them.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Componentization of software computer program components may be used, for example, in the context of developing automated tests for APIs. For several embodiments, each API is an activity container with items and all item manipulation is done using pathname strings. The mechanisms to define domains and cycle through items' values are the same. The core layer defines the basic classes like containers, items, typemaps, and activities. Specialized layers (for example Microsoft® Windows API and DirectX® API) are built on top of the core. Even more specialized layers (i.e., applications) could be built on top of those. Since all components are implemented using a common interface (container), any new layer is visible to the Shell applications with no change. The test application is not hard-coded as an executable, it exists in the form of nested containers. A GUI shell is used to change items and add or remove containers without a need to recompile the test.

Other advantages and features of the invention are described below.

### BRIEF DESCRIPTION OF THE DRAWINGS

Componentization of computer software programs is further described with reference to the accompanying drawings in which:

FIG. 1 is a flow chart illustrating a process for componentization of software computer programs;

FIG. 2 is a diagram illustrating mechanisms of an architecture for providing componentization of software computer programs;

FIG. 3 is a diagram illustrating the structural layout of components of an exemplary componentized Microsoft® Windows application;

FIG. 4 is a more detailed diagram of the structural layout of the components of FIG. 3;

FIG. 5 is a screenshot of a window that the exemplary componentized Microsoft® Windows application of FIGS. 3 and 4 creates;

FIG. 6 is a screenshot of a graphical user interface of a development tool for building applications using componentization of software computer programs as shown in FIGS. 1 through 4.

FIG. 7 is a more detailed screenshot than that of FIG. 6 indicating drag and drop and container cycling capabilities.

FIG. 8 is a more detailed screenshot than that of FIG. 6 indicating item domain cycling capabilities.

FIG. 9 is a block diagram representing an exemplary computing device suitable for use in conjunction with implementing the computer software componentization of FIGS. 1 through 6; and

FIG. 10 illustrates an exemplary networked computing environment in which many computerized processes may be implemented to perform the computer software componentization of FIGS. 1 through 8.

### DETAILED DESCRIPTION

Certain specific details are set forth in the following description and figures to provide a thorough understanding of various embodiments of the invention. Certain well-known details often associated with computing and software technology are not set forth in the following disclosure to avoid unnecessarily obscuring the various embodiments of the invention. Further, those of ordinary skill in the relevant art will understand that they can practice other embodiments of the invention without one or more of the details described below. Finally, while various methods are described with reference to steps and sequences in the following disclosure, the description as such is for providing a clear implementation of embodiments of the invention, and the steps and sequences of steps should not be taken as required to practice this invention.

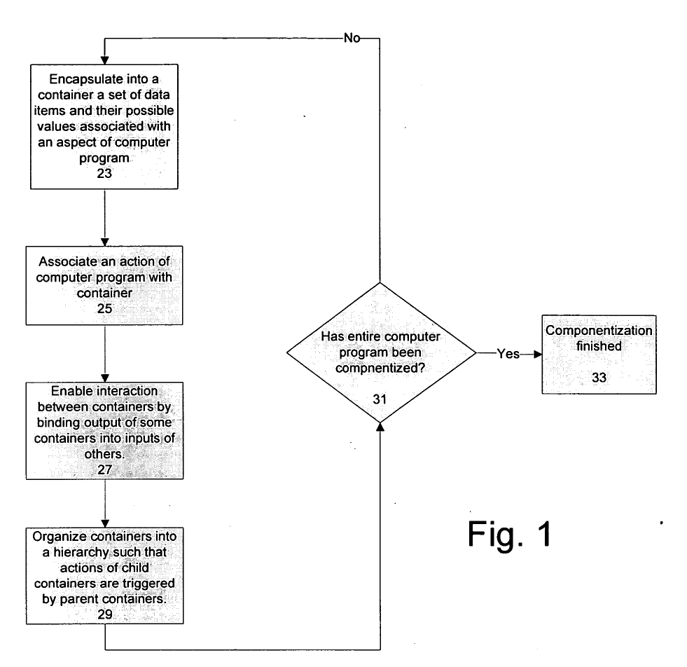

Referring to FIG. 1, shown is a flow chart illustrating a process for componentization of software computer programs. Componentization of software computer programs may be especially useful for testing programs or building prototypes of new programs because tests for various operations of the program may be easily built by connecting components in corresponding fashion without having to re-write code. A set of data items and their possible values associated with an aspect of a computer program is encapsulated 23 into a container along with an associated action 25 of the computer program. Interaction between the containers is enabled by binding output of some containers into inputs of others 27. The containers are then organized into a hierarchy such that actions of child containers are triggered by parent containers 29. Once the entire program has been componentized 31, the componentization process is complete 33 and testing of the program or building new programs based on the components is possible. Further details of the componentization process is described below in conjunction with the mechanisms of an architecture for providing componentization.

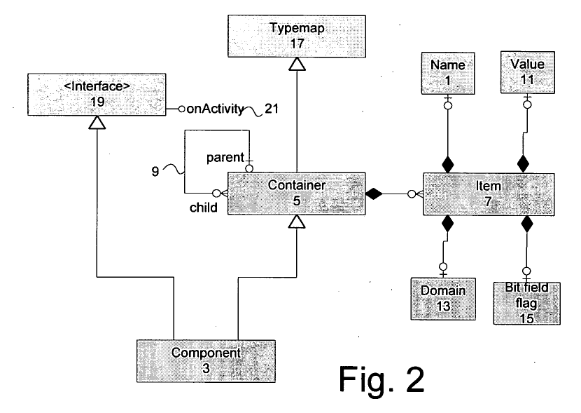

Referring next to FIG. 2, shown is a UML style diagram illustrating mechanisms of an architecture for providing componentization of software computer programs. The architecture provides efficient mechanisms to store generic data and to perform actions. In this example, an application programming interface (API) is that which is to be componentized for testing. A distinction is made between the application programming interface (API) parameterization and the action of calling the API. These two distinct ideas are encapsulated into a programming entity called a component 3.

The building block of a component is the Container 5 class. A container 5 holds items 7. Items 7 can be any type of data object, even another container 5 object. This allows one to build hierarchies of nested 9 containers 5. The fundamental distinction the architecture recognizes is if an object of type T is a container 5 or non-container object.

Items have four properties: a name 1, a value (of some type T) 11, a domain of possible assignable values of type T 13, and a bit-field flag 15 that defines additional properties of the item 7 (e.g., if the item is an input or output). Items 7 are referenced using a pathname. Pathnames are similar to standard hierarchical file system naming conventions where the individual names are delimited by a special separator character. Both absolute and relative pathnames are supported. An extension to the standard dot-notation is “. . . /A” which means to find an ancestor item named A.

The value 11 of an item may also be specified with an expression which evaluates to a type T value. Expressions are evaluated at runtime using a specialized C-like parser (vcalc). The expression may reference simple or complex types, other items, predefined functions, and even user defined functions. A special case of an expression is the link. A link is an absolute or relative pathname to another item such that the item's value is obtained from the linked item's value. Several links may be traversed before resolving the item's value.

The domain 13 of an item is used to cycle the item through interesting values in an automated and unified manner. Each cycle assignment serves as a different test case. Once domains 13 are established for one or more items 7, then the state of its container 5 (and descendant containers) is defined. The state is a unique integer number and is derived from dependent item domain 13 sets. It is possible to cycle the container 5 through selected states such that individual item 7 assignments are simultaneous made.

The container 5 class provides many methods that operate on it or the items 7 it contains. Some fundamental methods include, for example, operations to add, remove, set and get item values 11 or flags 15, set item domains 13, and enumerate the items 7 it stores.

For a set of logically related types (T₁, T₂, . . . , Tₙ), the universe of possible values for each type are stored in a Typemap class object 17. The item's domain set can reference the typemap 17 to obtain these values. A typemap 17 also provides mechanisms for textual input and output of a type's value (i.e. 3.14 as “3.14”), contains the allowable parent-child relationship 9 of container components, and is an object-factory for creating default values of a type. A single instance of a typemap 17 is shared by all components 3 that require it.

Heretofore, the data aspects of a container 5 have been discussed. Containers 5 may also have functionality associated with them. In the simplest case, a container 5 defines a single activity or action that it performs. The functionality of a container is defined in conjunction with an Interface class declaration 19. The interface class defines the abstract operations, procedures, and subroutines. Often, the functionality corresponds to event handling methods and is normally prefixed with “on,” such as, for example, onActivity 21.

The control flow of actions is induced by the parent-child relationship 9 of containers 5. The child activity, if enabled, is executed when instructed by its parent container 5. For example, one might imagine the parent's onCreateWindow 21 activity responding to the WM_CREATE messages by invoking the onCreateWindow 21 activity of its children. This is the basic form of control in the architecture for componentization.

The API components use multiple inheritances to derive from the container class and the activity interface. This allows them to define data (the API input and output parameters) and perform actions (call the API function). The API components 3 and associated typemaps 17 are compiled as dynamic link libraries (DLL) for modularity and easy reuse.

In the context of using the computer software program componentization described herein for testing APIs, a test for an API is defined by a sequence of API components. For example, a shell application (test manager) can save this definition in a textual (extensible markup language) XML format and later read this file, load the required DLL components 3 and typemaps 17, and recreate the original component settings and sequence.

In associating actions with containers, the action normally uses the values 11 of the container's data items 7 and possibly values from other containers' 5 data items 7. These external data items 7 are referenced using linked items. The way that activities are implemented is by first defining an abstract interface class 19 with the virtual method onActivity 21. Derived classes override this method with functionality unique to them.

```
class CActivityInterface
{
public:
    virtual ˜CActivityInterface( )
    {
    }
    virtual void onActivity( ) = 0;
};
```

Using multiple inheritance the container 5 and activity interface 19 classes are joined together. This class is used as the base class to implement any desired component 3.

```
class CActivity : public CContainer, public CActivityInterface
{
public:
    virtual void onActivity( )
    {
    }
protected:
    CActivity( )
    {
    }
};
```

The following describes an example of building components 3 that have activities. It demonstrates a familiar exercise that programmers tackle when learning a new language or system; how to create a program that writes the message “Hello World!” First, a small set of helper classes is outlined for managing a Microsoft® Windows application. Key is the idea that there are stages or phases associated with a window's lifetime. Theses standard stages are defined in an abstract interface class shown below.

```
class CGadgetInterface
{
public:
    virtual ˜CGadgetInterface( )
    {
    }
protected:
    virtual void onCreateWindow( ) = 0;
    virtual void onDestroyWindow( ) = 0;
    virtual void onSizeWindow( ) = 0;
    virtual void onDrawWindow( ) = 0;
    virtual void onIdleWindow( ) = 0;
};
```

Building on this is a specialized activity class that iterates through its items calling the onActivity method 21 for each.

```
class CActivityGadget : public CActivity, public CGadgetInterface
{
public:
    CActivityGadget( )
    {
    }
    virtual void onActivity( )
    {
        for_each( std::mem_fun< void, CActivityInterface >(
&CActivityInterface::onActivity ) );
    }
};
```

To make it easier to partition component activities with the different window stages, there are specialized grouping classes which call onActivity 21 on the particular window stage they're designed to handle.

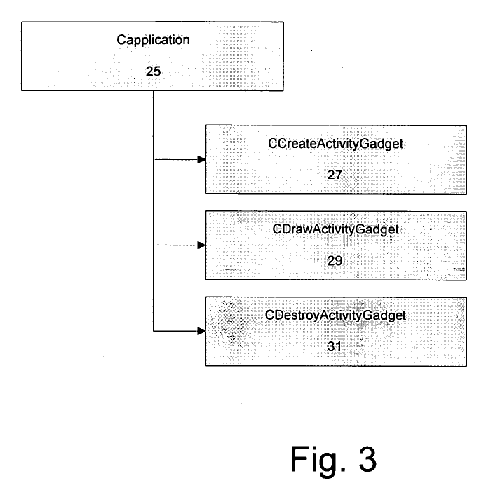

Referring next to FIG. 3, shown is a diagram illustrating the structural layout of components of the exemplary componentized Microsoft® Windows application described below including CApplication 25, CCreateActivityGadget 27, CDrawActivityGadget 29 and CDestroyActivityGadget 31. Shown below is an example of source code implementing these the lower level components of FIG. 3. CCreateActivityGadget 27, represents components that do something when the window is created. CDrawActivityGadget 29 represents components that do something when the window is repainted. CDestroyActivityGadget 31 represents components that do something when the window is destoyed.

```
class CCreateActivityGadget : public CActivityGadget
{
public:
    virtual void onCreateWindow( )
    {
        CActivityGadget::onActivity( );
    }
};
class CDestroyActivityGadget : public CActivityGadget
{
public:
    virtual void onDestroyWindow( )
    {
        CActivityGadget::onActivity( );
    }
};
class CDrawActivityGadget : public CActivityGadget
{
public:
    virtual void onDrawWindow( )
    {
        CActivityGadget::onActivity( );
    }
};
```

Finally, there is then a top-level application window class such as CApplication 25, that drives the application. Low-level messages are dispatched to the onCreate, onSize, onPaint, and onDestroy callback functions and these functions then call the interface methods 19.

```
class CApplication : public CContainer, public CGadgetInterface
{
public:
    CApplication( );
    void create( HINSTANCE hInstance );
    WPARAM run( );
    LRESULT close( );
protected:
    virtual void onCreateWindow( )
    {
        for_each (std::mem_fun< void, CWidgetGadgetInterface >(
&CWidgetGadgetInterface::onCreateWindow ) );
    }
    virtual void onDestroyWindow( )
    {
        for_each (std::mem_fun< void, CWidgetGadgetInterface >(
&CWidgetGadgetInterface::onDestroyWindow ) );
    }
    virtual void onSizeWindow( )
    {
        for_each (std::mem_fun< void, CWidgetGadgetInterface >(
&CWidgetGadgetInterface::onSizeWindow ) );
    }
    virtual void onDrawWindow( )
    {
        for_each (std::mem_fun< void, CWidgetGadgetInterface >(
&CWidgetGadgetInterface::onDrawWindow ) );
    }
    virtual void onIdleWindow( )
    {
        for_each (std::mem_fun< void, CWidgetGadgetInterface >(
&CWidgetGadgetInterface::onIdleWindow ) );
    }
    // message pump callbacks
    LRESULT onCreate( HWND hwnd, UINT uMsg, WPARAM
    wParam, LPARAM lParam )
    {
        onCreateWindow( );
        return 0;
    }
    LRESULT onSize( HWND hwnd, UINT uMsg, WPARAM wParam,
    LPARAM lParam )
    {
        onSizeWindow( );
        return 0;
    }
    LRESULT onPaint( HWND hwnd, UINT uMsg, WPARAM wParam,
    LPARAM lParam )
    {
        onDrawWindow( );
        return 0;
    }
    LRESULT onDestroy( HWND hwnd, UINT uMsg, WPARAM
    wParam, LPARAM lParam )
    {
        onDestroyWindow( );
        return 0;
    }
};
```

With the present example being a Microsoft® Windows application, there are several APIs needed to implement it. Below are a few examples of how these API functions are wrapped as components 3 with activities and then assembled into a working program. The Microsoft® Windows functions used are listed below:
CreateFont
GetClientRect
SelectObject
DeleteObject
GetDC
ReleaseDC
DrawText

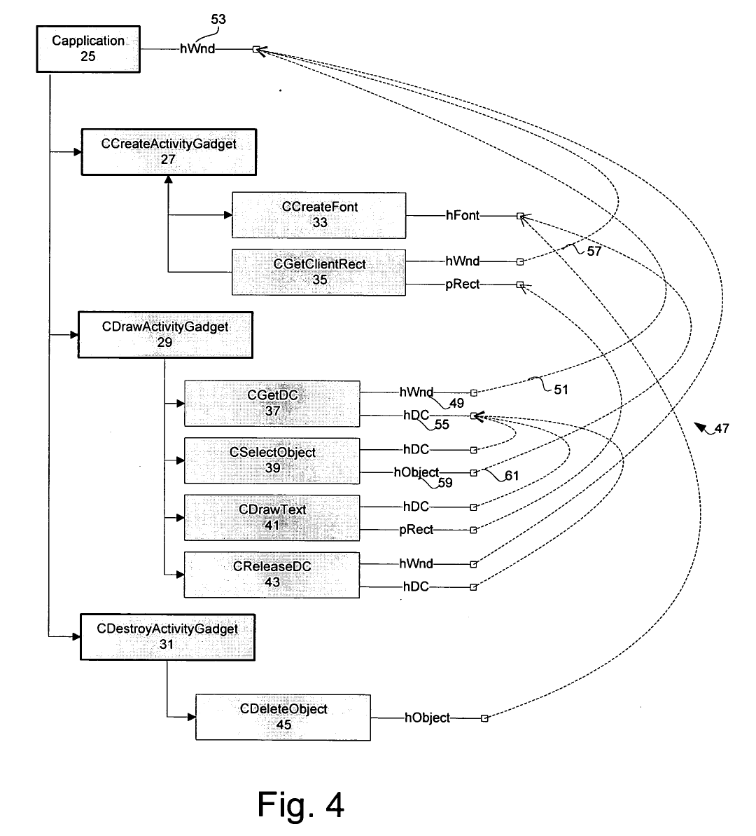

Accordingly, referring next to FIG. 4, shown is a more detailed diagram of the structural layout of the components of FIG. 3. These include the corresponding components CreateFont 33 and GetClientRect 35 under CCreateActivityGadget 27, components CGetDC 37, CSelectObject 39, CDrawText 41 and CReleaseDC 43 under CDrawActivityGadget 29, and components CDeleteObject 45 under CDestroyActivityGadget 31.

From the Microsoft® Windows Platform SDK documentation the CreateFont function has this signature

| | |
|---|---|
| HFONT CreateFont( | |
| int nHeight, | // height of font |
| int nWidth, | // average character width |
| int nEscapement, | // angle of escapement |
| int nOrientation, | // base-line orientation angle |
| int fnWeight, | // font weight |
| DWORD fdwItalic, | // italic attribute option |
| DWORD fdwUnderline, | // underline attribute option |
| DWORD fdwStrikeOut, | // strikeout attribute option |
| DWORD fdwCharSet, | // character set identifier |
| DWORD fdwOutputPrecision, | // output precision |
| DWORD fdwClipPrecision, | // clipping precision |
| DWORD fdwQuality, | // output quality |
| DWORD fdwPitchAndFamily, | // pitch and family |
| LPCTSTR lpszFace | // typeface name |
| ); | |

To wrap this function we first derive the class CCreateFont from the CActivity class.

```
class CCreateFont : public CActivity
{
public:
    CCreateFont( );
    virtual void onActivity( );
};
```

In the constructor, items 7 are added that correspond to the parameter name 1 in the function declaration choosing appropriate default values 11. The handle to the created font is stored as an output item.

```
CCreateFont::CCreateFont( )
{
    addItem( L“nHeight”, 0 );
    addItem( L“nWidth”, 0 );
    addItem( L“nEscapement”, 0 );
    addItem( L“nOrientation”, 0 );
    addItem( L“fnWeight”, (int) FW_DONTCARE );
    addItem( L“fdwItalic”, (BOOL) FALSE );
    addItem( L“fdwUnderline”, (BOOL) FALSE );
    addItem( L“fdwStrikeOut”, (BOOL) FALSE );
    addItem( L“fdwCharSet”, (DWORD) ANSI_CHARSET );
    addItem( L“fdwOutputPrecision”, (DWORD)
    OUT_DEFAULT_PRECIS );
    addItem( L“fdwClipPrecision”, (DWORD)
    CLIP_DEFAULT_PRECIS );
    addItem( L“fdwQuality”, (DWORD) DEFAULT_QUALITY );
    addItem( L“fdwPitch”, (DWORD) DEFAULT_PITCH );
    addItem( L“fdwFamily”, (DWORD) FF_DONTCARE );
    addItem( L“lpszFace”, L“” );
    addItem( L“hFont”, (HFONT) 0, uOutputItem );
}
```

To define the onActivity function the values 11 of the items 7 are fetched and the CreateFont function is called.

| void CCreateFont::onActivity( ) | |
|---|---|
| { | |
| int nHeight, nWidth, nEscapement, nOrientation, fnWeight; | |
| BOOL fdwItalic, fdwUnderline, fdwStrikeOut; | |
| DWORD fdwCharset, fdwOutputPrecision, fdwClipPrecision, | |
| fdwQuality, fdwPitch, fdwFamily; | |
| std::wstring *lpszFace; | |
| HFONT hFont; | |
| getItem( L“nHeight”, nHeight ); | |
| getItem( L“nWidth”, nWidth ); | |
| getItem( L“nEscapement”, nEscapement ); | |
| getItem( L“nOrientation”, nOrientation ); | |
| getItem( L“fnWeight”, fnWeight ); | |
| getItem( L“fdwItalic”, fdwItalic ); | |
| getItem( L“fdwUnderline”, fdwUnderline ); | |
| getItem( L“fdwStrikeOut”, fdwStrikeOut ); | |
| getItem( L“fdwCharSet”, fdwCharSet ); | |
| getItem( L“fdwOutputPrecision”, fdwOutputPrecision ); | |
| getItem( L“fdwClipPrecision”, fdwClipPrecision ); | |
| getItem( L“fdwQuality”, fdwQuality ); | |
| getItem( L“fdwPitch”, fdwPitch ); | |
| getItem( L“fdwFamily”, fdwFamily ); | |
| getItemPtr( L“lpszFace”, &lpszFace); | |
| hFont = ::CreateFont( | nHeight, |
| | nWidth, |
| | nEscapement, |
| | nOrientation, |
| | fnWeight, |
| | fdwItalic, |
| | fdwUnderline, |
| | fdwStrikeOut, |
| | fdwCharSet, |
| | fdwOutputPrecision, |
| | fdwClipPrecision, |
| | fdwQuality, |
| | fdwPitch \| pfdwFamily, |
| | lpszFace->c_str( ) ); |

setItem( L”hFont”, hFont );
}

Some functions require output of others as their input. Such corresponding components for these type of functions requiring linked items are depicted by dashed lines 47 in FIG. 4. For example, the GetDC function 37 requires a window handle as input. A linked item 49 is used that contains the path 51 to another item 53 (which can be in another container 25) that holds the window handle. The returned handle to the DC is stored as an output item 55.

```
HDC GetDC(
  HWND hWnd  // handle to window
);
class CActivityGetDC : public CActivity
{
public:
    CActivityGetDC( );
    virtual void onActivity( );
};
CActivityGetDC::CActivityGetDC( )
{
    addItemLink( L“hWnd”, L“.../Window/hWnd” );
    addItem( L“hDC”, (HDC) 0, uOutputItem );
}
void CActivityGetDC::onActivity( )
{
    HWND hWnd;
    HDC hDC;
    getItem( L”hWnd”, hWnd );
    hDC = ::GetDC( hWnd );
    setItem( L”hDC”, hDC );
}
```

The GetClientRect function 35 is next. It too requires a window handle 57 and stores a pointer to the client rectangle. The client rectangle is stored as member object and the item's 7 value 11 is a pointer 57 to this rectangle.

```
BOOL GetClientRect(
    HWND hWnd,
    LPRECT lpRect
);
class CActivityGetClientRect : public CActivity
{
public:
    CActivityGetClientRect( );
    virtual void onActivity( );
protected:
    RECT m_ClientRect;
};
CActivityGetClientRect::CActivityGetClientRect( )
{
    addItemLink( L“hWnd”, L“.../Window/hWnd” );
    addItemPtr( L“pRECT”, &CActivityGetClientRect::m_ClientRect );
    addItem( L”Return”, (BOOL) FALSE, uOutputItem );
}
void CActivityGetClientRect::onActivity( )
{
    HWND hWnd;
    BOOL bReturn;
    getItem( L”hWnd”, hWnd );
    bReturn = ::GetClientRect( hWnd, &m_ClientRect );
    setItem( L”Return”, bReturn );
}
```

Next is the SelectObject 39 function. Again a link item 59 is used, but this casts the target of the link to a HGDIOBJ. This is needed since different types of HGDIOBJ exist. In this case link 61 to hFont of type HFONT is casted to a HGDIOBJ.

| HGDIOBJ SelectObject( | |
|---|---|
| HDC hdc, | // handle to DC |
| HGDIOBJ hgdiobj | // handle to object |
| ); | |

```
class CActivitySelectObject : public CActivity
{
public:
    CActivitySelectObject( );
    virtual void onActivity( );
};
CActivitySelectObject::CActivitySelectObject( )
{
    addItemLink( L“hDC”, L“” );
    addItemLinkCast( L“hObject”, L“” );
    addItem( L“hRetObject”, (HGDIOBJ) 0, uOutputItem );
}
void CActivitySelectObject::onActivity( )
{
    HDC hDC;
    HGDIOBJ hObject, hRetObject;
    getItem( L”hDC”, hDC );
    getItem( L”hObject”, hObject );
    hRetObject = ::SelectObject( hDC, hObject );
    setItem( L”hRetObject”, hRetObject );
}
```

The final example is the DrawText 41 function. It requires the length of the string as input. To make using this component 3 more simple for the programmer, the onSetItem method is overridden and if the “String” item is being changed, then the “nCount” item is set automatically to its size.

| | |
|---|---|
| int DrawText( | |
| HDC hDC, | // handle to DC |
| LPCTSTR lpString, | // text to draw |
| int nCount, | // text length |
| LPRECT lpRect, | // formatting dimensions |
| UINT uFormat | // text-drawing options |
| ); | |

```
class CActivityDrawText : public CActivity
{
public:
    CActivityDrawText( );
    virtual void onActivity( );
protected:
    virtual void onSetItem( CCoreItemInfo *pItemInfo );
};
CActivityDrawText::CActivityDrawText( )
{
    addItemLink( L“hDC”, L“” );
    addItem( L“String”, L“” );
    addItem( L“nCount”, 0 );
    addItemLink( L“pRect”, L”” );
    addItem( L“Format”, (UINT)DT_TOP );
    addItem( L“Return”, 0, uOutputIem );
}
void CActivityDrawText::onSetIem( CCoreItemInfo *pItemInfo )
{
      CActivity::onSetItem( pItemInfo );
      if ( 0 == wcscmp( L“String”, pItemInfo->getName( ) ) )
      {
        setItem( L”nCount”,
        static_cast< int >( m_pString->length( ) ) );
      }
}
void CActivityDrawText::onActivity( )
{
    HDC hDC;
    std::wstring *pString;
    int nCount, iReturn;
    RECT *pRect;
    UINT Format;
    getItem( L“hDC”, hDC );
    getItemPtr( L“String”, &pString );
    getItem( L“nCount”, nCount );
    getItem( L“pRect”, pRect );
    getItem( L“Format”, Format );
    iReturn = ::DrawText( hDC, pString->c_str( ),
    nCount, pRect, Format );
    setItem( L”Return”, iReturn );
}
```

The basic building-block components 3 are now defined. To build a working application, these components 3 need to be assembled under the appropriate window stages and in the proper order. Items 7 that require non-default settings must now have their desired values 11 set and all linked items 47 must have their target item's path set.

class CSample : public CApplication
{
Public:
CSample( );
};
CSample::CSample( )
{

| | |
|---|---|
| addItem( | L”Create Activities”, CCreateActivityGadget( ) ); |
| addItem( | L”Create Activities/CreateFont”, CCreateFont( ) ); |
| addItem( | L”Create Activities/GetClientRect”, CGetClientRect( ) ); |
| addItem( | L”Draw Activities”, CDrawActivityGadget( ) ); |
| addItem( | L”Draw Activities/GetDC”, CGetDC( ) ); |
| addItem( | L”Draw Activities/SelectObject (new font)”, CSelectObject( ) ); |
| addItem( | L”Draw Activities/DrawText”, CDrawText( ) ); |
| addItem( | L”Draw Activities/SelectObject (previous font)”, CSelectObject( ) ); |
| addItem( | L”Draw Activities/ReleaseDC”, CReleaseDC( ) ); |
| addItem( | L”Destroy Activities”, CDestroyActivityGadget( ) ); |
| addItem( | L”Destroy Activities/DeleteObject”, CDeleteObject( ) ); |
| setItem( | L”Window/lpWindowName”, L”Sample” ); |
| setItem( | L”Create Activities/CreateFont/nHeight”, 72 ); |
| setItem( | L”Create Activities/CreateFont/fnWeight”, DWORD( FW_SEMIBOLD ) ); |
| setItem( | L”Create Activities/CreateFont/lpszFace”, L”Kunstler Script” ); |
| setItem( | L”Create Activities/GetClientRect/hWnd”, L”.../Window/hWnd”, false ); |
| setItem( | L”Create Activities/GetDC/hWnd”, L”.../Window/hWnd”, false ); |
| setItem( | L”Draw Activities/SelectObject (new font)/hDC”, |
| | L”../GetDC/hDC”, false ); |
| setItem( | L”Draw Activities/SelectObject (new font)/hObject”, |
| | L”../Create Activities/CreateFont/hFont”, false ); |
| setItem( | L”Draw Activities/DrawText/hDC”, L”../GetDC/hDC”); |
| setItem( | L”Draw Activities/DrawText/String”, L”Hello World!”); |
| setItem( | L”Draw Activities/DrawText/pRect”, |
| | L”.../Create Activities/GetClientRect/pRECT”, false ); |
| setItem( | L”Draw Activities/DrawText/Format”, |
| | DWORD( DT_CENTER \| DT_VCENTER \| DT_SINGLELINE ) ); |
| setItem( | L”Draw Activities/SelectObject (previous font)/hObject”, |
| | L”../GetDC/hDC”); |
| setItem( | L”Draw Activities/SelectObject (previous font)/hObject”, |
| | L”.../SelectObject (new font)/hRetObject”, false ); |
| setItem( | L”Draw Activities/ReleaseDC/hWnd”, L”.../Window/hWnd”, false ); |
| setItem( | L”Draw Activities/ReleaseDC/hDC”, L”../GetDC/hDC”, false ); |
| setItem( | L”Destroy Activities/DeleteObject/hObject”, |
| | L” .../Create Activities/CreateFont/hFont” ); |
| } | |

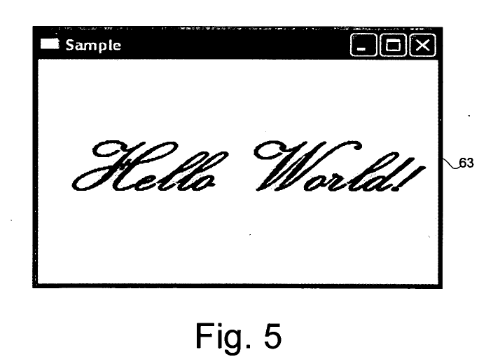

The application can now be run by instantiating the application object and directing it to run and will result of a window 63 such as that shown in FIG. 5 being drawn.

```
in main( )
{
    CSample app;
    app.create( NULL );
    return app.run( );
}
```

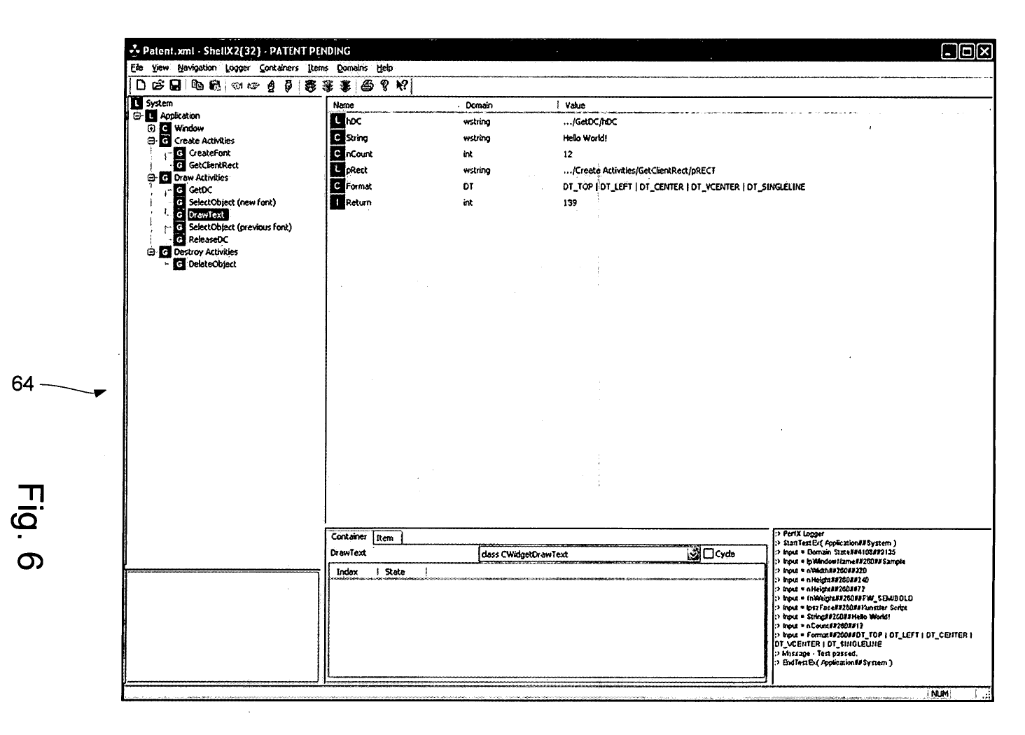

Referring next to FIG. 6, shown is a screenshot 64 of a graphical user interface GUI of a development tool for building tests and applications using componentization of software computer programs as shown in FIGS. 1 through 4. The computer software program componentization described above allows multiple shells to be used that all operate on the same underlying component data. Also, a command line shell can be used to load an XML file and run the tests in automation.

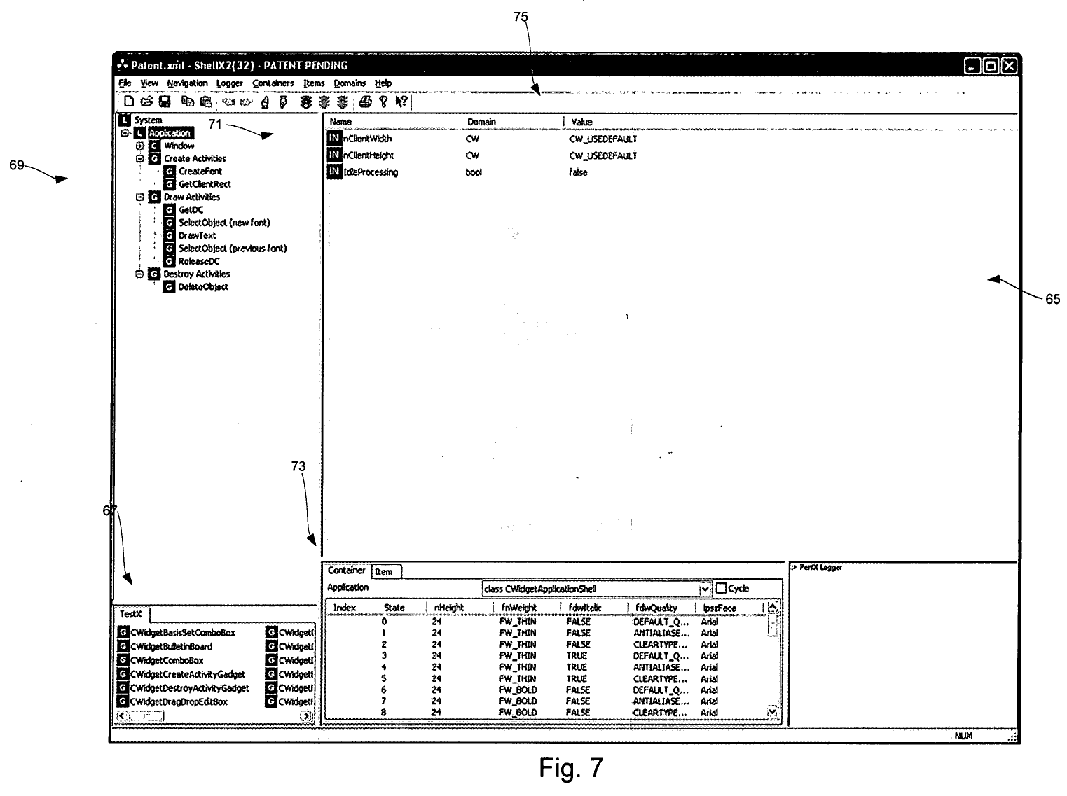

Referring next to FIG. 7, shown is a more detailed screenshot than that of FIG. 6 indicating drag and drop and container cycling capabilities. Intuitive drag and drop operations 67 allows one to add permitted components to the selected container. Items of the selected container 71 are display with their current value 75 which may be changed by the user. The domain of a container 73 lists all possible combinations of descendant items' domain values. A subset of which may be selected and the container cycled on those chosen states.

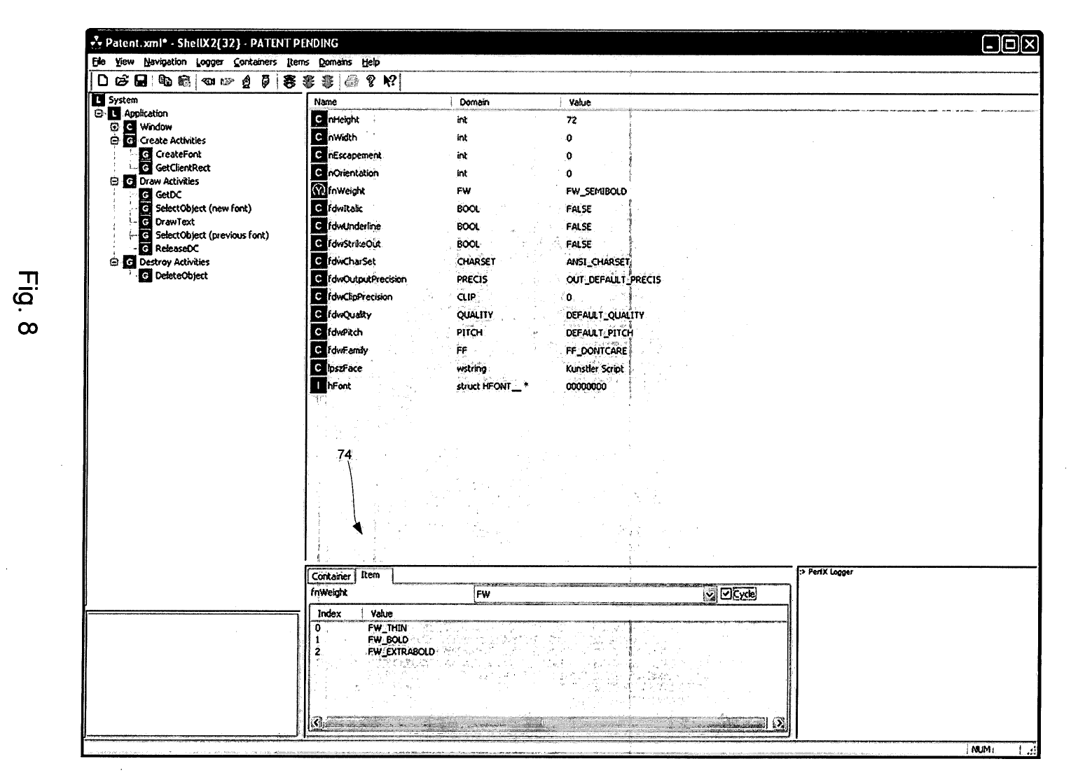

Referring next to FIG. 8, shown is a more detailed screenshot than that of FIG. 6 indicating item domain cycling capabilities. Item domains 74 may be specified for the selected item and cycling on those values enabled.

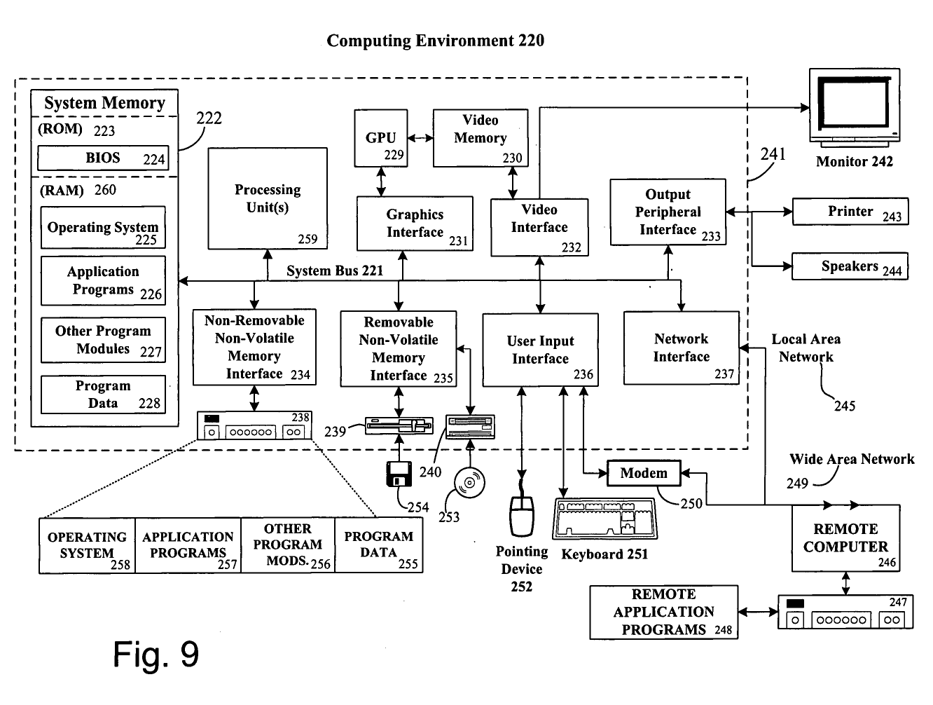

Referring next to FIG. 9, shown is a block diagram representing an exemplary computing device suitable for use in conjunction with implementing the processes described above. For example, the computer executable instructions that carry out the processes and methods for componentization of software computer programs may reside and/or be executed in such a computing environment as shown in FIG. 9. The computing system environment 220 is only one example of a suitable computing environment and is not intended to suggest any limitation as to the scope of use or functionality of the invention. Neither should the computing environment 220 be interpreted as having any dependency or requirement relating to any one or combination of components illustrated in the exemplary operating environment 220.

Aspects of the invention are operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

Aspects of the invention may be implemented in the general context of computer-executable instructions, such as program modules, being executed by a computer. Generally, program modules include routines, programs, objects, components, data structures, etc. that perform particular tasks or implement particular abstract data types. Aspects of the invention may also be practiced in distributed computing environments where tasks are performed by remote processing devices that are linked through a communications network. In a distributed computing environment, program modules may be located in both local and remote computer storage media including memory storage devices.

An exemplary system for implementing aspects of the invention includes a general purpose computing device in the form of a computer 241. Components of computer 241 may include, but are not limited to, a processing unit 259, a system memory 222, and a system bus 221 that couples various system components including the system memory to the processing unit 259. The system bus 221 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 241 typically includes a variety of computer readable media. Computer readable media can be any available media that can be accessed by computer 241 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 241. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 222 includes computer storage media in the form of volatile and/or nonvolatile memory such as read only memory (ROM) 223 and random access memory (RAM) 260. A basic input/output system 224 (BIOS), containing the basic routines that help to transfer information between elements within computer 241, such as during start-up, is typically stored in ROM 223. RAM 260 typically contains data and/or program modules that are immediately accessible to and/or presently being operated on by processing unit 259. By way of example, and not limitation, FIG. 9 illustrates operating system 225, application programs 226, other program modules 227, and program data 228.

The computer 241 may also include other removable/non-removable, volatile/nonvolatile computer storage media. By way of example only, FIG. 9 illustrates a hard disk drive 238 that reads from or writes to non-removable, nonvolatile magnetic media, a magnetic disk drive 239 that reads from or writes to a removable, nonvolatile magnetic disk 254, and an optical disk drive 240 that reads from or writes to a removable, nonvolatile optical disk 253 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 238 is typically connected to the system bus 221 through an non-removable memory interface such as interface 234, and magnetic disk drive 239 and optical disk drive 240 are typically connected to the system bus 221 by a removable memory interface, such as interface 235.

The drives and their associated computer storage media discussed above and illustrated in FIG. 9, provide storage of computer readable instructions, data structures, program modules and other data for the computer 241. In FIG. 9, for example, hard disk drive 238 is illustrated as storing operating system 258, application programs 257, other program modules 256, and program data 255. Note that these components can either be the same as or different from operating system 225, application programs 226, other program modules 227, and program data 228. Operating system 258, application programs 257, other program modules 256, and program data 255 are given different numbers here to illustrate that, at a minimum, they are different copies. A user may enter commands and information into the computer 241 through input devices such as a keyboard 251 and pointing device 252, commonly referred to as a mouse, trackball or touch pad. Other input devices (not shown) may include a microphone, joystick, game pad, satellite dish, scanner, or the like. These and other input devices are often connected to the processing unit 259 through a user input interface 236 that is coupled to the system bus, but may be connected by other interface and bus structures, such as a parallel port, game port or a universal serial bus (USB). A monitor 242 or other type of display device is also connected to the system bus 221 via an interface, such as a video interface 232. In addition to the monitor, computers may also include other peripheral output devices such as speakers 244 and printer 243, which may be connected through a output peripheral interface 233.

The computer 241 may operate in a networked environment using logical connections to one or more remote computers, such as a remote computer 246. The remote computer 246 may be a personal computer, a server, a router, a network PC, a peer device or other common network node, and typically includes many or all of the elements described above relative to the computer 241, although only a memory storage device 247 has been illustrated in FIG. 9. The logical connections depicted in FIG. 9 include a local area network (LAN) 245 and a wide area network (WAN) 249, but may also include other networks. Such networking environments are commonplace in offices, enterprise-wide computer networks, intranets and the Internet.

When used in a LAN networking environment, the computer 241 is connected to the LAN 245 through a network interface or adapter 237. When used in a WAN networking environment, the computer 241 typically includes a modem 250 or other means for establishing communications over the WAN 249, such as the Internet. The modem 250, which may be internal or external, may be connected to the system bus 221 via the user input interface 236, or other appropriate mechanism. In a networked environment, program modules depicted relative to the computer 241, or portions thereof, may be stored in the remote memory storage device. By way of example, and not limitation, FIG. 9 illustrates remote application programs 248 as residing on memory device 247. It will be appreciated that the network connections shown are exemplary and other means of establishing a communications link between the computers may be used.

It should be understood that the various techniques described herein may be implemented in connection with hardware or software or, where appropriate, with a combination of both. Thus, the methods and apparatus of the invention, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the invention. In the case of program code execution on programmable computers, the computing device generally includes a processor, a storage medium readable by the processor (including volatile and non-volatile memory and/or storage elements), at least one input device, and at least one output device. One or more programs that may implement or utilize the processes described in connection with the invention, e.g., through the use of an API, reusable controls, or the like. Such programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

Although exemplary embodiments may refer to utilizing aspects of the invention in the context of one or more stand-alone computer systems, the invention is not so limited, but rather may be implemented in connection with any computing environment, such as a network or distributed computing environment. Still further, aspects of the invention may be implemented in or across a plurality of processing chips or devices, and storage may similarly be effected across a plurality of devices. Such devices might include personal computers, network servers, handheld devices, supercomputers, or computers integrated into other systems such as automobiles and airplanes.

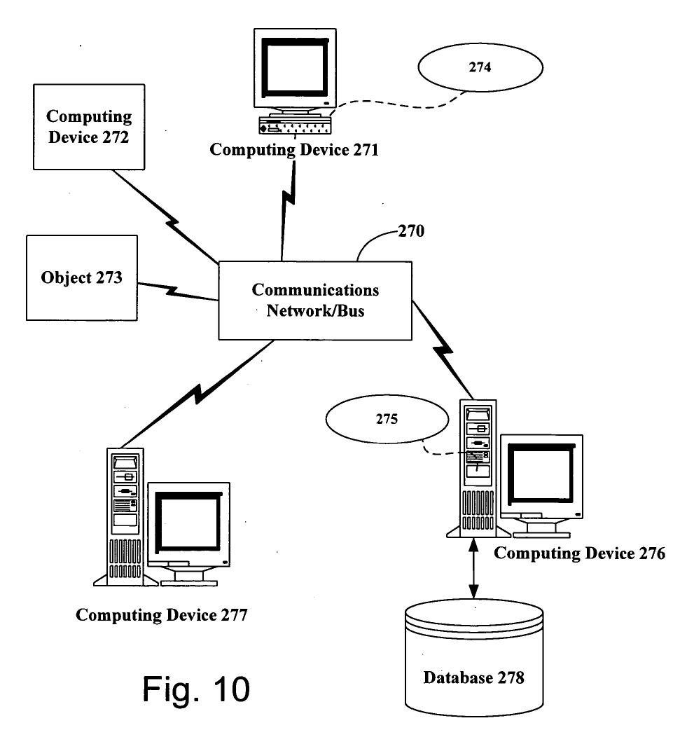

Referring next to FIG. 10, shown is an exemplary networked computing environment in which many computerized processes may be implemented to perform the processes described above and shown in FIGS. 1 through 6 of componentization of software computer programs. For example, parallel computing may be part of such a networked environment with various clients on the network of FIG. 10 performing different parts of the processes for componentization shown in FIGS. 1 through 6. One of ordinary skill in the art can appreciate that networks can connect any computer or other client or server device, or in a distributed computing environment. In this regard, any computer system or environment having any number of processing, memory, or storage units, and any number of applications and processes occurring simultaneously is considered suitable for use in connection with the systems and methods provided.

Distributed computing provides sharing of computer resources and services by exchange between computing devices and systems. These resources and services include the exchange of information, cache storage and disk storage for files. Distributed computing takes advantage of network connectivity, allowing clients to leverage their collective power to benefit the entire enterprise. In this regard, a variety of devices may have applications, objects or resources that may implicate the processes described herein.

FIG. 10 provides a schematic diagram of an exemplary networked or distributed computing environment. The environment comprises computing devices 271, 272, 276, and 277 as well as objects 273, 274, and 275, and database 278. Each of these entities 271, 272, 273, 274, 275, 276, 277 and 278 may comprise or make use of programs, methods, data stores, programmable logic, etc. The entities 271, 272, 273, 274, 275, 276, 277 and 278 may span portions of the same or different devices such as PDAs, audio/video devices, MP3 players, personal computers, etc. Each entity 271, 272, 273, 274, 275, 276, 277 and 278 can communicate with another entity 271, 272, 273, 274, 275, 276, 277 and 278 by way of the communications network 270. In this regard, any entity may be responsible for the maintenance and updating of a database 278 or other storage element.

This network 270 may itself comprise other computing entities that provide services to the system of FIG. 10, and may itself represent multiple interconnected networks. In accordance with an aspect of the invention, each entity 271, 272, 273, 274, 275, 276, 277 and 278 may contain discrete functional program modules that might make use of an API, or other object, software, firmware and/or hardware, to request services of one or more of the other entities 271, 272, 273, 274, 275, 276, 277 and 278.

It can also be appreciated that an object, such as 275, may be hosted on another computing device 276. Thus, although the physical environment depicted may show the connected devices as computers, such illustration is merely exemplary and the physical environment may alternatively be depicted or described comprising various digital devices such as PDAs, televisions, MP3 players, etc., software objects such as interfaces, COM objects and the like.

There are a variety of systems, components, and network configurations that support distributed computing environments. For example, computing systems may be connected together by wired or wireless systems, by local networks or widely distributed networks. Currently, many networks are coupled to the Internet, which provides an infrastructure for widely distributed computing and encompasses many different networks. Any such infrastructures, whether coupled to the Internet or not, may be used in conjunction with the systems and methods provided.

A network infrastructure may enable a host of network topologies such as client/server, peer-to-peer, or hybrid architectures. The “client” is a member of a class or group that uses the services of another class or group to which it is not related. In computing, a client is a process, i.e., roughly a set of instructions or tasks, that requests a service provided by another program. The client process utilizes the requested service without having to “know” any working details about the other program or the service itself. In a client/server architecture, particularly a networked system, a client is usually a computer that accesses shared network resources provided by another computer, e.g., a server. In the example of FIG. 10, any entity 271, 272, 273, 274, 275, 276, 277 and 278 can be considered a client, a server, or both, depending on the circumstances.

A server is typically, though not necessarily, a remote computer system accessible over a remote or local network, such as the Internet. The client process may be active in a first computer system, and the server process may be active in a second computer system, communicating with one another over a communications medium, thus providing distributed functionality and allowing multiple clients to take advantage of the information-gathering capabilities of the server. Any software objects may be distributed across multiple computing devices or objects.

Client(s) and server(s) communicate with one another utilizing the functionality provided by protocol layer(s). For example, HyperText Transfer Protocol (HTTP) is a common protocol that is used in conjunction with the World Wide Web (WWW), or “the Web.” Typically, a computer network address such as an Internet Protocol (IP) address or other reference such as a Universal Resource Locator (URL) can be used to identify the server or client computers to each other. The network address can be referred to as a URL address. Communication can be provided over a communications medium, e.g., client(s) and server(s) may be coupled to one another via TCP/IP connection(s) for high-capacity communication.

In light of the diverse computing environments that may be built according to the general framework provided in FIG. 10 and the further diversification that can occur in computing in a network environment such as that of FIG. 10, the systems and methods provided herein cannot be construed as limited in any way to a particular computing architecture. Instead, the invention should not be limited to any single embodiment, but rather should be construed in breadth and scope in accordance with the appended claims.

What is claimed:

1. A method of computer program componentization comprising:
encapsulating at least one aspect of a computer program into a software component container, said aspect comprising a set of data items associated with the computer program, a domain of possible assignable values of at least one of the data items according to a type of the data item, and at least one action that the computer program performs.

2. The method of claim 1, further comprising:
organizing said software component container with at least one other component container corresponding to another aspect of the computer program, each software component container created according to said encapsulation; and
enabling interaction between software components by binding the output of one software component associated with a software component container to the input of another software component associated with a software component container.

3. The method of claim 2 further comprising:
forming a logical hierarchy of a plurality of the software component containers by forming a parent-child relationship between the plurality of the software component containers wherein the action the computer program performs associated with the aspect of the computer program encapsulated in a child software component container is executed when instructed by a parent software component container of the child software component container.

4. The method of claim 3 further comprising creating a new computer program by using said components that encapsulate aspects of the computer program.

5. The method of claim 3 further comprising creating a test program for the computer program by using a plurality of said components that encapsulate aspects of the computer program desired to be tested.

6. The method of claim 5 further comprising:
creating operable connections between said components by using a graphical user interface to place a graphical image representing a component next to another graphical image representing another component.

7. The method of claim 6 wherein the computer program is an application programming interface.

8. A system for computer program componentization comprising:
means for encapsulating at least one aspect of a computer program into a software component container, said aspect comprising a set of data items associated with the computer program, a domain of possible assignable values of at least one of the data items according to a type of the data item, and at least one action that the computer program performs.

9. The system of claim 8, further comprising:
means for organizing said software component container with at least one other component container corresponding to another aspect of the computer program, each software component container created according to said encapsulation; and
means for enabling interaction between software components by binding the output of one software component associated with a software component container to the input of another software component associated with a software component container.

10. The system of claim 9 further comprising:
means for forming a logical hierarchy of a plurality of the software component containers by forming a parent-child relationship between the plurality of the software component containers wherein the action the computer program performs associated with the aspect of the computer program encapsulated in a child software component container is executed when instructed by a parent software component container of the child software component container.

11. The system of claim 10 further comprising creating a new computer program by using said components that encapsulate aspects of the computer program.

12. The system of claim 10 further comprising means for creating a test program for the computer program by using a plurality of said components that encapsulate aspects of the computer program desired to be tested.

13. The system of claim 12 further comprising:
means for creating operable connections between said components by using a graphical user interface to place a graphical image representing a component next to another graphical image representing another component.

14. The system of claim 13 wherein the computer program is an application programming interface.

15. A graphical user interface for building computer software programs comprising means for creating operable connections between components by using a graphical user interface to place a graphical image representing a component, said component encapsulating at least one aspect of a computer program into a software component container, next to another graphical image representing another component encapsulating another aspect of the computer program into a software component container.

16. A computer readable medium having instructions thereon for performing the method of claim 1.

17. A computer readable medium having instructions thereon for performing the method of claim 2.

18. A computer readable medium having instructions thereon for performing the method of claim 3.

19. A computer readable medium having instructions thereon for performing the method of claim 4.

20. A computer readable medium having instructions thereon for performing the method of claim 5.
